(19) United States
(12) Patent Application Publication
(10) Pub. No.: US 2018/0197217 A1
(43) Pub. Date: Jul. 12, 2018

(54) METHOD OF BIDDING ONLINE SERVICES

(71) Applicant: NEXCOM International Co., Ltd., New Taipei City (TW)

(72) Inventors: Mao-Chang LIN, New Taipei City (TW); Chiy-Ferng PERNG, New Taipei City (TW); Cheng-Yu TSENG, New Taipei City (TW); Yi-Chung SHEN, New Taipei City (TW)

(73) Assignee: NEXCOM International Co., Ltd., New Taipei City (TW)

(21) Appl. No.: 15/493,147

(22) Filed: Apr. 21, 2017

(30) Foreign Application Priority Data
Jan. 6, 2017 (TW) 106100521

(51) Int. Cl. G06Q 30/06; H04L 29/08; H04L 12/58

(52) U.S. Cl. CPC G06Q 30/0611; H04L 67/327; H04L 67/20; H04L 51/04; H04L 51/10; H04L 67/306

(57) ABSTRACT

A method of bidding online services is disclosed. The method includes following steps: receiving a service request from a user; executing a pairing process to search a service satisfying the service request; executing a bidding process to select at least one of plurality of users when determining that the service has been assigned to another user; re-assigning the service to the selected user; establishing a communication between the selected user and a provider of the service for enabling the provider to provide online service to the user once receiving a using request from the user and a providing request from the provider.

### BACKGROUND OF THE INVENTION

### Field of the Invention

The present invention relates to a method, especially to a method of bidding online service.

### Description of Prior Art

In daily life, people often have many problems beyond their abilities, for example, how to edit a film, how to declare income tax, how to remove computer failures, how to operate computer software or how to perform investment analysis. Thus people need assistance from experts of different fields.

However, people often are not able to get help by an expert from a field of the problem to be solved, because people are not familiar with the field. Besides, though the experts of different fields have expertise, the experts cannot provide the expertise to people having problems because currently a convenient way to share the expertise is not available.

### SUMMARY OF THE INVENTION

The present invention mainly provides a method of bidding online service, and provides an online service most satisfying a user request, and provides a mechanism of bidding online service.

Accordingly, the present invention discloses a method of bidding online service, the method includes: a) receiving a service request corresponding to a user data by a server; b) executing a pairing process to search one of a plurality of service data satisfying the service request, wherein each of the service data respectively corresponds to a provider data; c) executing a bidding process to select at least one of the plurality of user data, if determining that the service data satisfying the service request has been assigned to another a user data; d) re-assigning the service data satisfying the service request to the user data selected in the bidding process; and e) receiving a using request corresponding to the user data selected from a user device, and establishing an instant communication connection between the user device and the provider device, when receiving a provide request corresponding to the service data satisfying the provide request from a provider device.

The present invention can effectively determine a service needed by a user by a pairing process, and can effectively determine an optimal user by a bidding mechanism.

### BRIEF DESCRIPTION OF DRAWING

One or more embodiments of the present disclosure are illustrated by way of example and not limitation in the figures of the accompanying drawings, in which like references indicate similar elements. These drawings are not necessarily drawn to scale.

FIG. 1 shows a structural diagram of a system of bidding online service according to a first embodiment of the present invention.

FIG. 2 shows a flowchart of a method of bidding online service according to a first embodiment of the present invention.

FIG. 3A shows a flowchart of a first part of a method of bidding online service according to a second embodiment of the present invention.

FIG. 3B shows a flowchart of a second part of a method of bidding online service according to a second embodiment of the present invention.

FIG. 4 shows a partial flowchart of a method of bidding online service according to a third embodiment of the present invention.

### DETAILED DESCRIPTION OF THE INVENTION

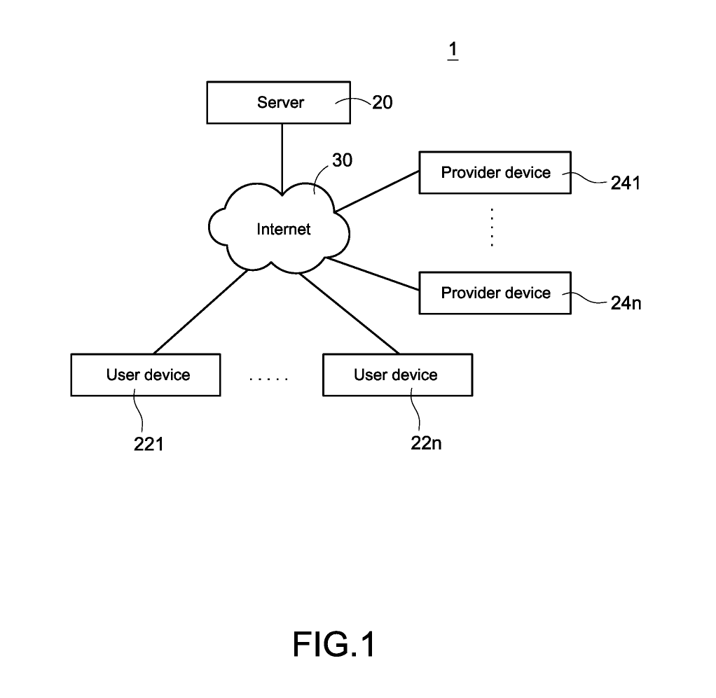

The present invention mainly provides a pairing platform technology, applied to the system 1 of bidding online service shown in FIG. 1. The aforementioned pairing platform technology records a service type or a specific content provided by the experts, after the system 1 receives the registration of the experts, and automatically pairs the most appropriate expert when a registered user has a service request. The system 1 is further used as a relay point to provide an instant communication service between the user and the expert.

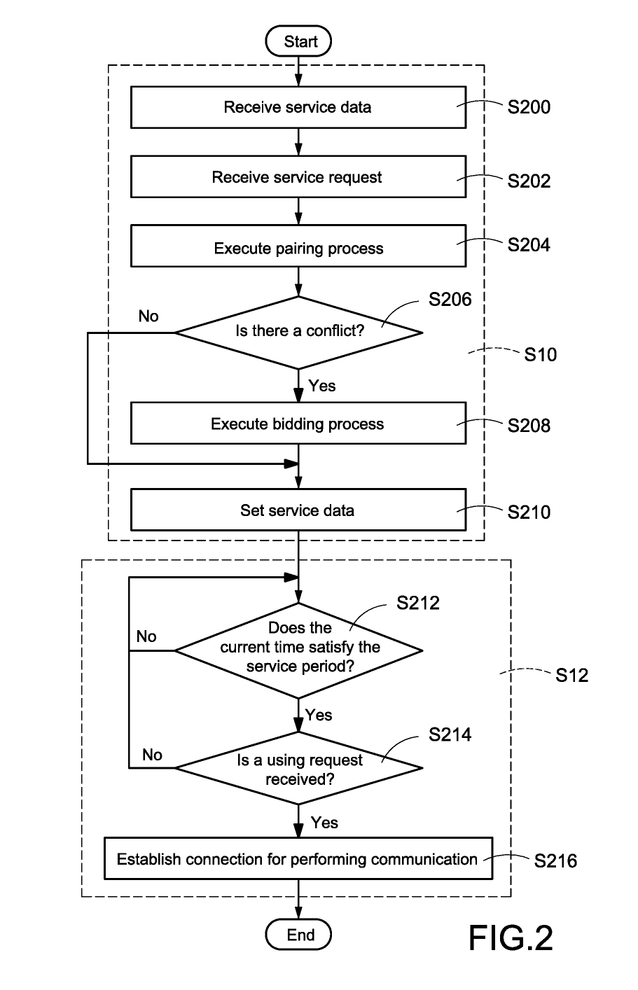

Please refer to both FIG. 1 and FIG. 2 first, FIG. 1 shows a scheme diagram of a system of bidding online service according to a first embodiment of the present invention, FIG. 2 shows a flowchart of a method of bidding online service according to a first embodiment of the present invention. The method of bidding online service according to each embodiment of the present invention is mainly implemented by the system 1 of bidding online service shown in FIG. 1.

Specifically, the service system 1 of bidding online mainly includes a server 20. The server 20 receives a corresponding request data and a corresponding return data by connecting an internet 30 from a plurality of user devices 221-22n or a plurality of provider devices 241-24n. Further, the user devices 221-22n are owned by a user having problems, the provider devices 241-24n are owned by an expert providing expertise or having ability to solve the problems, the server 20 is built by a third party (for example, a service intermediary agent or a service pairing platform provider).

In an embodiment, the server is a webpage server displaying graphic user interface (GUI) on a webpage browser on the user devices 221-22n or provider devices 241-24n, by sending webpage codes to the user devices 221-22n or the provider devices 241-24n for executing, and receiving an operation information and a feedback information by the GUI.

In another embodiment, the server 20 is a cloud calculating server, the user devices 221-22n or provider devices 241-24n displays GUI after executing an installed APP, and makes the server 20 receive an operation and feedback information by the GUI.

It should be noted that, the user devices 221-22n and provider devices 241-24n are named only for identifying the user owning the computer device, not for limiting the type of the user devices 221-22n and provider devices 241-24n. The user devices 221-22n and provider devices 241-24n can be of the same type or different types of computer device, such as laptops, smartphones, wearable devices, tablets, desktops, or device of other types.

Besides, in the present invention, the term “user” represents the aforementioned user having problems, the user data includes the whole or part of personal data provided by the user when the user registers to the third party, the term “provider” represents the aforementioned expert, the provider data includes the whole or part of data provided by provider, when the provider registers to the third party.

The server 20 may store a service pairing computer program and a service providing computer program, and the server 20 synchronously or respectively executes the above program to implement the service pairing function and the service providing function. Besides, the server 20 executes step S10: setting a service data according to the service request, to pair a particular service provided by the provider to a particular user with the request, after the server 20 executes service pairing computer program. Specifically, step S10 includes the following steps.

Step S200: the server 20 receives a plurality of service data from plurality of provider devices 241-24n respectively through the internet 30.

Specifically, each provider may register to the third party in advance, the third party may make the personal data (such as account and password, account data or service type that can be provided) of the provider be logged in as the provider data and stored in a database of the server 20 (not shown) after receiving the registration.

In the following, each provider may operate the provider device (for example, the provider devices 241) to send the provider login request (the provider login request may include account and password) to server 20, the server 20 allows the provider devices 241 to login after determining that the received provider login request passes verification. The provider may further operate the provider devices 241 to set a service data, and send the set service data to the server 20 after login is completed, the server 20 make the received service data correspond to the provider data and be stored in the database. The aforementioned service data includes a service type (the service type may be a type categorized by the third party or a self-introduction of the provider) and a service period (that is, the period that the provider can stay online and provide service).

In this way, the database of the server 20 may store a plurality of service data having different service types, or a plurality of service data having different service periods.

Step S202: the server 20 receives service request from any one of the user devices 221-22n by the internet 30.

Specifically, any user can register to the third party in advance, the third party may make the personal data (such as account and password, account data or service type needed) of the user be logged in as the user data and stored in a database of the server 20 after receiving the registration.

In the following, the user can operate the user device (for example, the provider devices 221) to send the user login request (the user login request may include account and password) to server 20, the server 20 allows the user devices 221 to login after determining that the received user login request passes verification. The user may further operate the user devices 221 to set a service request, and send the set service request to the server 20 after login is completed, the server 20 make the received service request correspond to the user data and be stored. The aforementioned service request includes a request type (the service type can be a type categorized by the third party or a self-introduction of the user) and a request period (that is, the period that the user can stay online and get service).

In this way, the server 20 obtains the request content of the user.

Step S204: the server 20 executes a pairing process to the received service request, to determine at least one service data satisfying the service request.

Specifically, the server 20 searches the service data having the service type satisfying the request type of the service request in the database, and also having the service period satisfying the request period of the service request.

Further, if a search result includes a plurality of service data satisfying, the server 20 can send a search result message to a user device 221, a user operates a user device 221 to increase a limit condition (for example, an evaluation record of the provider data to which the service data corresponds needs to be more preferential) of the service request, or to select one of the plurality of service data satisfying the service request after checking the search result message. Then, the server 20 can filter the plurality of service data according to the service request for obtaining the service data which satisfying the service request, and the filtered service data, or the service data selected by the user can be used as a result of the pairing process.

Step S206: the server 20 determines if there is a conflict in the service data determined in the pairing process. Specifically, the server 20 determines if the service data has been assigned to another user data (for example, the user data corresponding to the user owning the user devices 222) in advance, that is, the service has been assigned to another user for using in advance, and cannot be provided to the current user.

If the server 20 determines there is a conflict, that is, the service data has been assigned to another user data, then step S208 is executed. Otherwise, the server 20 executes step S210.

Step S208: the server 20 executes a bidding process to the service data having the conflict, to re-determine the user data to which the service data should be assigned.

Specifically, the server 20 provides a bidding platform for the service corresponding to the service data, when the same service is paired to a plurality of users. Therefore, the server 20 may allow a plurality of users performing bidding, and assign the service to the most appropriate user (for example, highest bidding, optimal evaluation record or optimal user in terms of other criterions) according to a bidding result, that is, assigning the service data to the user data corresponding to the optimal user.

In this way, the embodiment can effectively solve the problem of assigning scarce service, and can effectively provide the optimal user to the service provider.

For example, the server 20 may send a bidding notification message to a user device 221 sending service request and to another user device 222 that the service data originally assigned, to notify the users to bid for the service. Then, the server 20 selects one of the user data corresponding to the user devices 221, 222 (for example, selecting the user data corresponding to the user devices 221), and to set the corresponding bidding data to the bidding data (such as bidding amount) according to the bidding data (such as bidding amount) received from the user devices 221, 222.

It should be noted that, though the example in the embodiment is the server 20 selecting one of the plurality of user data, it is not limited here. A number of the user data selected by the server 20 can be set in view of a top limit of a number of the service data to be assigned. For example, the server 20 selects 5 user data at most when the top limit of the number of the service data is 5. Besides, when the number of the users assigned by the activity data is no more than 5, the server will not execute the bidding process, that is, there is determined to be no conflict in step S206.

Step S210: the server 20 re-assigns the service data to the user data selected in step S208, that is, the service data is re-assigned to the user data corresponding to the user device 221, and the service data is set as completion pairing. Then, the aforementioned data is stored and the pairing is ended.

Step S12 can be executed after the server 20 executes the service provide computer program: providing an instant communication service between the user and the expert according to the set service data. Specifically, step S12 includes the following steps.

Step S212: the server 20 determines if the current time satisfies the service period of the service data of any completion pairing.

If current time satisfies the service period of the service data of any completion pairing, then the server 20 reads the service data. Otherwise, the server executes step S212 again.

Step S214: the server 20 determines if a using request corresponding to the particular user data is received from a user device 221, and a provide request corresponding to the service data (corresponding to the particular provider data)which satisfying the service request is received from provider devices 241.

If the server 20 receives the aforementioned using request and provide request, then step S216 is executed. Otherwise, the server 20 executes step S212 again.

Specifically, the user may operate the user device 221 in advance to login the pairing platform(sending a user login request to the server 10 as mentioned above), and may operate a user device 221 to send the aforementioned using request to the server 10 during the service period. Similarly, the provider corresponding to the service of the service data which satisfying the service request also may operate the provider device 241 in advance to login pairing platform (that is, sending provider login request to server 10 as mentioned above), and can operate the provider devices 241 to send the aforementioned provide request to the server 10 during the service period.

Step S216: the server 20 establishes the instant communication connection between the user device 221 and the provider devices 24 for performing communication. The aforementioned instant communication connection can be an instant text message connection, instant video connection, instant speech connection or instant communication connection of other types.

In this way, the provider owning the provider devices 241 provides service to the user owning the user device 221 through the aforementioned instant communication connection.

The embodiment can allow a user to effectively obtain the needed service, and provide a service channel for the provider.

In an embodiment, the server 20 is used as a relay point of the user device 221 and the provider device 241 to provide the aforementioned instant communication connection. Specifically, the server 20 establishes a first instant connection with the user device 221 first, and then establishes second instant connection with the provider device 241. Then, the server 20 may transfer the data relative to the service (like video data, speech data or text data) received from the user device 221 by the second instant connection to the provider device 241 by the first instant connection, and can transfer the data relative to the service received from the provider device 241 by the second instant connection to the user device 221 by the first instant connection.

In this way, the user device 221 and provider device 241 can perform the instant communication without the need to know the internet location of each other. Besides, the instant communication may also be performed when the user device 221 and provider devices 241 uses dynamic IP address, by the relay point technology in the embodiment.

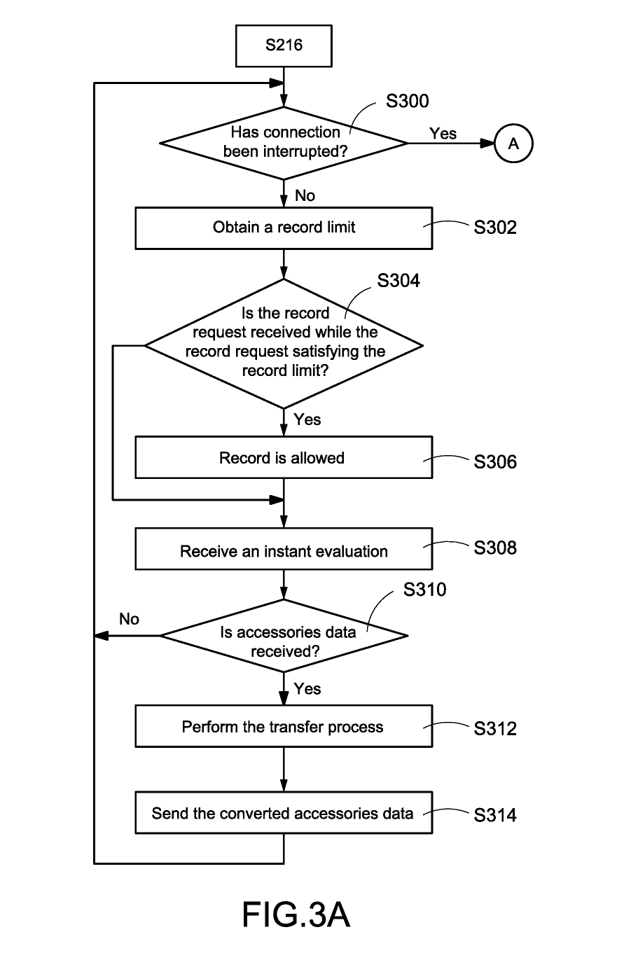

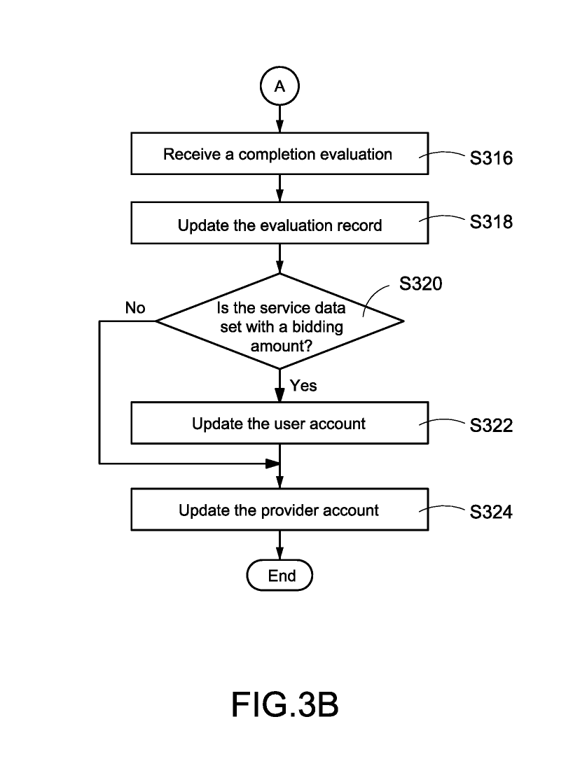

Please refer to FIG. 1 to FIG. 3B, FIG. 3A shows a flowchart of a first part of a method of bidding online service according to a second embodiment of the present invention, FIG. 3B shows a flowchart of a second part of a method of bidding online service according to a second embodiment of the present invention. In the embodiment, the instant communication connection is an instant video connection or instant speech connection. Compared to the embodiment shown in FIG. 2, after step S216, the embodiment of bidding online service method further includes the following steps.

Step S300: the server 20 determines if the instant communication connection has been interrupted, that is, determining if any one of the user and the provider ends this service.

If the server 20 determines that the instant communication connection has not been interrupted, then step S302 is executed. Otherwise, the server 20 executes step S316.

Step S302: the server 20 obtains a record limit corresponding to the service data.

The aforementioned record limit can be set by a user, provider or third party, for example, the record limit is set when the user sends a using request, the record limit is set when the provider sends a provide request, the record limit is set by the third party in advance, or the record limit is dynamically set by the user, provider or third party during the instant communication connection period. For example, the user or provider can temporarily set the record limit to be record forbidden when part of video content relates to personal privacy, and can change the record limit to be record allowed when the video does not relate to personal privacy.

In an embodiment, the record limit includes set values like “record not allowed”, “record allowed”, “only voice recorded” or “only image captured”. If the record limit is “record not allowed”, the server 20 may perform anti-theft process like encrypting the transferred multimedia data, converting the transferred multimedia data to non-universal coding or embedded watermark, to avoid record violation of the user or provider. If the record limit is “record allowed”, the server 20 would not perform anti-theft process to the transferred multimedia data. Further, the server 20 also automatically packages the transferred multimedia data to be a multimedia file (for example, each 60 minutes packaged to be a single video file), for the convenience of the provider or user storing. If the record limit is “only voice recorded”, the server 20 would not perform anti-theft process to the transferred speech data. If the record limit is “only image captured”, the server 20 would perform anti-theft process to the transferred multimedia, and would generate a non-encrypted screenshot image when receiving an image capture request and provide to a user or provider.

Step S304: the server 20 determines if the record request (for example, voice record request, video record request or image capture request) is received from a user device 221 or provider device 241, and determines if the received record request satisfies the aforementioned record limit.

If the server 20 receives the record request and the record request satisfies the record limit, then the server 20 executes step S306. Otherwise, step S308 is executed.

Step S306: the server 20 allows the user device 221 or provider device 241 record the multimedia data (video data or speech data) transmitted by instant communication connection.

In this way, the embodiment can implement the record function, and can effectively avoid bootlegging by executing steps S302-S306.

Step S308: the server 20 receives an instant evaluation during the instant communication connection period. Specifically, during the provide service, the provider can randomly or periodically operate the provider device 241 to send the user instant evaluation to the server 20 for evaluating the user in service. Similarly, during the provide service, the user also can randomly or periodically operate the user device 221 to send the provider instant evaluation to the server 20 for evaluating the provider in service.

Further, the server 20 instantly or periodically feedbacks the received evaluation to the user and provider, after receiving the aforementioned user instant evaluation and provider instant evaluation, that is, transferring the user instant evaluation to the user device 221, and transferring the provider instant evaluation to the provider device 241.

In this way, the embodiment implements the instant evaluation function in service, to allow the provider to adjust service content according to the instant evaluation, thus enabling the provider to provide service with better quality. The embodiment allows the user to adjust attitude (for example, adjusting listening attitude or question content) according to the instant evaluation, thus become a better service user.

Step S310: the server 20 determines if accessories data (for example, text file, video file, or 3D image file) is received from sending terminal (the user device 221 or provider device 241).

If the server 20 receives accessories data, then step S312 is executed. Otherwise, the server executes step S300 again.

Step S312: the server 20 performs the transfer process to the accessories data, to transfer the accessories data to a readable format of the receiving terminal (the provider device 241 or a user device 221).

In an embodiment, the server 20 executes the imaging process to the accessories data to generate an accessories image corresponding to an execution result of the accessories data.

Step S314: the server 20 sends the converted accessories data (for example, accessories image) to the receiving terminal. The embodiment converts the accessories data to a readable format of the receiving terminal, to effectively show the execute result of the accessories data to the receiving terminal.

For example, the accessories data is a computer drawing file (for example, CAD file), if the user device 221 is not installed with a computer drawing program, the user device 221 cannot open the type of computer drawing file. As a result, the provider is unable to explain the content of the computer drawing file. The embodiment converts the accessories data to the readable format (for example, image file) of the user device 221 such that the user device 221 can display the content of the computer drawing file well, and the provider can easily explain to the user.

If the server 20 determines that the instant communication connection has been interrupted in step S300, then step S316 is executed: the server 20 receives a completion evaluation. Specifically, after the service is completed, the provider may operate the provider device 241 to send a user completion evaluation to the server 20, to evaluate the user receiving the service. Relatively, the user can also operate the user device 221 to send the provider completion evaluation to the server 20, to evaluate the provider providing the service.

Step S318: the server 20 updates the evaluation record of the user data according to the user instant evaluation received during the instant communication connection period, and according to the user completion evaluation received after the instant communication connection is interrupted. The server 20 updates the evaluation record of the provider data according to the provider instant evaluation received during the instant communication connection existence period, and according to the provider completion evaluation received after the instant communication connection is interrupted.

Further, the server 20 respectively sends the evaluation record of the updated user data, and the evaluation record of the user data to the user device 221 and provider device 241, after the update is completed.

In this way, the embodiment updates the evaluation record according to the evaluation during the service, and the evaluation after the end of the service, whereby the evaluation record can truly show eligibility of the provider and the user.

Step S320: the server 20 determines if the service data is set with a bidding amount, that is, determining if the service data is subject to the bidding process.

If the server 20 determines the service data is set with the bidding amount, then step S322 is executed. Otherwise, the server 20 executes step S324.

Step S322: the server 20 updates the user account of the user data according to the bidding amount, for example, charging the bidding amount from the user account.

Step S324: the server 20 updates the provider account of the provider data according to the bidding amount.

In an embodiment, if the service data is not set with the bidding amount (that is, the service data is not subject to the bidding process), then the server 20 adds a first amount to provider account. If the service data is set with the bidding amount, then the server 20 adds a second amount to the provider account, wherein the second amount is larger than the first amount.

In this way, if the service is not subject to bidding, then the provider obtains less feedback. If the service is subject to the bidding, then the provider obtains more feedback, the embodiment uses the aforementioned mechanism to encourage the provider to improve the quality to gain more chance to bid the service. Besides, in the embodiment, if the used service is not subject to the bidding, the user will not be charged, such that the user is more willing to use the service.

Though the user is only charged by the service subject to the bidding in the embodiment, but it is not limited here. In another embodiment, the user can be charged in all services.

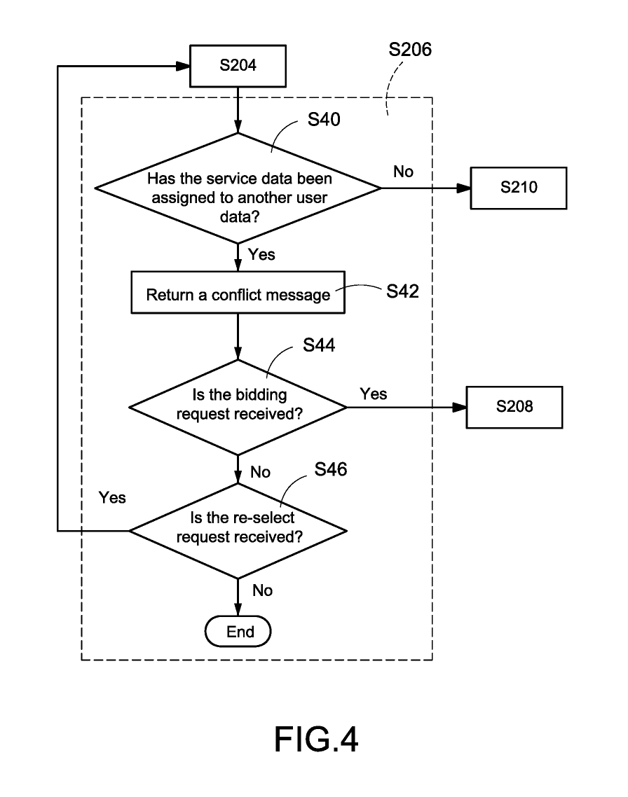

Please refer to FIG. 1 to FIG. 2, FIG. 4, FIG. 4 shows a partial flowchart of a method of bidding online service according to a third embodiment of the present invention. Compared to the embodiment shown in FIG. 2, step S206 of the method of bidding online service according to the embodiment further includes the following steps.

Step S40: the server 10 determines if the service data satisfying the service request has been assigned to another user data (for example, the user data corresponding to the user devices 242) in advance.

If the service data has been assigned to another user data, then the server 10 executes step S42. Otherwise, step S210 is executed.

Step S42: the server 10 returns a conflict message to the user device 221, to prompt the user to perform the bidding or re-set the service request.

Then, the user reads conflict message, and operates the user device 221 to set the bidding amount and send the bidding request to the server 10, or change the service request (for example, changing the request type or request period) and send the re-select request to the server 10.

Step S44: the server 10 determines if the bidding request is received from the user device 221.

If the server 10 receives the bidding request, then step S208 is executed to perform the bidding process. Otherwise, the server 10 executes step S46.

Step S46: the server 10 determines if the re-select request is received from the user device 221.

If the server 10 receives the re-select request, then the re-select request is used as a new service request and step S204 is executed again to execute the pairing process to search the service data satisfying the new re-select request.

The embodiment makes the user select bidding or change request when the conflict exists, to provide the user further more flexibility of selection, and improve the using experience.

Thus, particular embodiments have been described. Other embodiments are within the scope of the following claims. For example, the actions recited in the claims may be performed in a different order and still achieve desirable results.

What is claimed is:

1. A method of bidding online service, the method comprising:
a) receiving a service request corresponding to a user data by a server;
b) executing a pairing process to search one service data satisfying the service request in a plurality of service data, wherein each of the service data corresponds to a provider data;
c) executing a bidding process to select at least one of the plurality of user data, if determining that the service data satisfying the service request has been assigned to another user data;
d) re-assigning the service data satisfying the service request to the user data selected in the bidding process; and
e) establishing an instant communication connection between the user device and the provider device, when receiving a provide request corresponding to the service data satisfying the provide request from a provider device, and when receiving a using request corresponding to the selected user data from a user device.

2. The method of bidding online service of claim 1, wherein the step a comprises:
a1) receiving a user login request corresponding to the user data; and
a2) receiving the service request after the user login request passing a verification, wherein the service request comprises a request type and a request period.

3. The method of bidding online service of claim 2, wherein the method further comprises following steps before the step b:
f1) receiving a provider login request corresponding to the provider data; and
f2) receiving and storing the service data corresponding to the provider data after the provider login request passing the verification, wherein the service data comprises a service type and a service period.

4. The method of bidding online service of claim 3, wherein the step b is searching the service data with the service type satisfying the request type, and with the service period satisfying the request period.

5. The method of bidding online service of claim 3, wherein the step e establishes the instant communication connection when a current time satisfies the service period, and the using request and the provide request are received.

6. The method of bidding online service of claim 1, wherein the step c comprises:
c1) returning a conflict message to the user device when determining that the service data satisfying the service request has been assigned to another user data;
c2) executing the bidding process when receiving a bidding request from the user device; and
c3) executing the pairing process to search the service data satisfying the re-select request when receiving a re-select request from the user device.

7. The method of bidding online service of claim 1, wherein the instant communication connection is an instant video connection or an instant speech connection, the method of bidding online service further comprises:
g1) obtaining a record limit corresponding to the service data satisfying the service request; and
g2) allowing the user device or the provider device to record a video data or a speech data transmitted by the instant communication connection when receiving a record request and the record request satisfying a record limit.

8. The method of bidding online service of claim 1, further comprising:
h1) receiving a user instant evaluation from the provider device, and receiving a provider instant evaluation from the user device during a period of the instant communication connection;
h2) receiving a user completion evaluation from the provider device, and receiving a provider completion evaluation from the user device after the instant communication connection being interrupted; and
h3) updating an evaluation record of the user data according to the user instant evaluation and the user completion evaluation, and updating an evaluation record of the provider data according to the provider instant evaluation and the provider completion evaluation.

9. The method of bidding online service of claim 1, further comprising:
i1) receiving an accessories data;
i2) executing a imaging process to the accessories data to generate an accessories image; and
i3) sending the accessories image to the user device or the provider device for performing display.

10. The method of bidding online service of claim 1, wherein the step c) further sets a bidding amount corresponding to the service data after selecting the user data, and the method of bidding online service further comprises a step j) updating a user account of the user data, and a provider account of the provider data according to the bidding amount when the bidding amount being set in the service data.
